(19) United States
(12) Patent Application Publication
(10) Pub. No.: US 2025/0246069 A1
(43) Pub. Date: Jul. 31, 2025

(54) DATA COLLECTION DEVICE, DATA COLLECTION METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Masamichi Ohsugi, Sunto-gun Shizuoka-ken (JP)

(73) Assignee: TOYOTA JIDOSHA KABUSHIKI KAISHA, Toyota-shi Aichi-ken (JP)

(21) Appl. No.: 19/037,360

(22) Filed: Jan. 27, 2025

(30) Foreign Application Priority Data
Jan. 31, 2024 (JP) 2024-013353

(51) Int. Cl. G08G 1/01

(52) U.S. Cl. CPC G08G 1/0112

(57) ABSTRACT

A data collection device acquires at least measurement result of a surrounding situation in front of a host vehicle in a travel direction from a surrounding situation sensor measuring the surrounding situation, determines whether recognition result of a recognition target included in the surrounding situation at a first time and the recognition result of the recognition target at a second time which is a time later than the first time coincide, and performs a process of uploading the measurement result used for the recognition of the recognition target at the first time and the measurement result used for the recognition of the recognition target at the second time to a server when it is determined that the recognition result of the recognition target at the first time and the recognition result of the recognition target at the second time do not coincide.

### CROSS-REFERENCE TO RELATED APPLICATIONS

This application claims priority to Japanese Patent Application No. 2024-013353 filed Jan. 31, 2024, the entire contents of which are herein incorporated by reference.

### FIELD

The present disclosure relates to data collection device, data collection method, and non-transitory recording medium.

### BACKGROUND

PTL 1 (JP-A-2020-198018) discloses a technique in which result of object identification is upload to a server, the object identification is performed in a vehicle. In the technique described in PTL 1, when the object identification is appropriately performed and when identification score is higher than a threshold value, the result of object identification appropriately performed is uploaded to the server.

If all various sensor data obtained by performing measurement in the vehicle which is traveling is acquired and uploaded to the server, communication load and storage capacity increase, and cost becomes unnecessarily high. On the other hand, if only the result of object identification appropriately performed is uploaded to the server as the technique described in PTL 1, there is a possibility that uploaded data is not used effectively.

### SUMMARY

In view of the above-described points, it is an object of the present disclosure to provide data collection device, data collection method, and non-transitory recording medium that enable effective use of data uploaded to a server.

(1) One aspect of the present disclosure is a data collection device including a processor configured to: acquire at least measurement result of a surrounding situation in front of a host vehicle in a travel direction from a surrounding situation sensor which measures the surrounding situation; determine whether recognition result of a recognition target included in the surrounding situation at a first time and the recognition result of the recognition target at a second time which is a time later than the first time coincide, recognition of the recognition target being performed by using the measurement result of the surrounding situation; and perform a process of uploading the measurement result used for the recognition of the recognition target at the first time and the measurement result used for the recognition of the recognition target at the second time to a server when it is determined that the recognition result of the recognition target at the first time and the recognition result of the recognition target at the second time do not coincide.

(2) In the data collection device of the aspect (1), the processor may be configured to perform the process of uploading time series measurement result including the measurement result used for the recognition of the recognition target at the first time and the measurement result used for the recognition of the recognition target at the second time to the server.

(3) In the data collection device of the aspect (1) or (2), the processor may be configured to acquire sensor information indicating mounting position and posture of the surrounding situation sensor with respect to the host vehicle and vehicle information indicating speed and yaw rate of the host vehicle, and perform the process of uploading the sensor information and the vehicle information to the server.

(4) Another aspect of the present disclosure is a data collection method including: acquiring at least measurement result of a surrounding situation in front of a host vehicle in a travel direction from a surrounding situation sensor which measures the surrounding situation; determining whether recognition result of a recognition target included in the surrounding situation at a first time and the recognition result of the recognition target at a second time which is a time later than the first time coincide, recognition of the recognition target being performed by using the measurement result of the surrounding situation; and performing a process of uploading the measurement result used for the recognition of the recognition target at the first time and the measurement result used for the recognition of the recognition target at the second time to a server when it is determined that the recognition result of the recognition target at the first time and the recognition result of the recognition target at the second time do not coincide.

(5) Another aspect of the present disclosure is a non-transitory recording medium having recorded thereon a computer program for causing a processor to perform a process including: acquiring at least measurement result of a surrounding situation in front of a host vehicle in a travel direction from a surrounding situation sensor which measures the surrounding situation; determining whether recognition result of a recognition target included in the surrounding situation at a first time and the recognition result of the recognition target at a second time which is a time later than the first time coincide, recognition of the recognition target being performed by using the measurement result of the surrounding situation; and performing a process of uploading the measurement result used for the recognition of the recognition target at the first time and the measurement result used for the recognition of the recognition target at the second time to a server when it is determined that the recognition result of the recognition target at the first time and the recognition result of the recognition target at the second time do not coincide.

According to the present disclosure, it is possible to enable effective use of data uploaded to a server.

### BRIEF DESCRIPTION OF DRAWINGS

FIG. 1 is a view showing an example of a host vehicle 1 to which a data collection device 16 of a first embodiment is applied.

FIG. 2 is a view showing an example of a surrounding situation in front of the host vehicle 1 in a travel direction measured by a surrounding situation sensor 11 at a first time.

FIG. 3 is a view showing an example of the surrounding situation in front of the host vehicle 1 in the travel direction measured by the surrounding situation sensor 11 at a second time which is a time later than the first time.

FIG. 4 is a view showing an example of a relationship between the host vehicle 1 and a server SV and the like.

FIG. 5 is a flowchart for explaining an example of a process performed by a processor 163 of the data collection device 16 of the first embodiment.

### DESCRIPTION OF EMBODIMENTS

Below, referring to the drawings, embodiments of data collection device, data collection method, and non-transitory recording medium of the present disclosure will be explained.

### First Embodiment

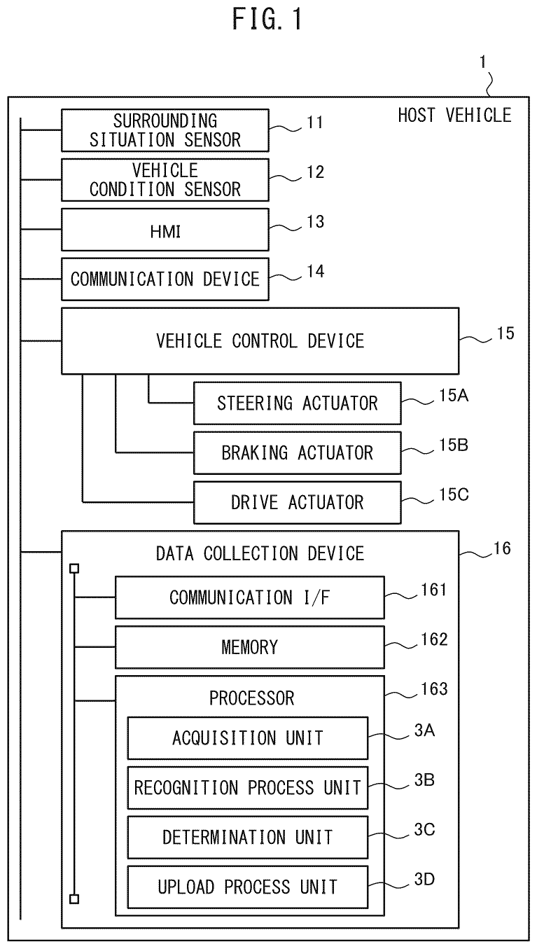

FIG. 1 is a view showing an example of a host vehicle 1 to which a data collection device 16 of a first embodiment is applied. In the example shown in FIG. 1, the host vehicle 1 includes surrounding situation sensor 11, vehicle condition sensor 12, HMI (Human Machine Interface) 13, communication device 14, vehicle control device 15, steering actuator 15A, braking actuator 15B, drive actuator 15C, and data collection device 16.

The surrounding situation sensor 11 measures a surrounding situation (e.g., obstacle, surrounding vehicle, pedestrian or the like existing in the vicinity) in front of the host vehicle 1 in a travel direction and transmits measurement result of the surrounding situation in front of the host vehicle 1 in the travel direction to the vehicle control device 15 and the data collection device 16. The surrounding situation sensor 11 includes, for example, camera, LiDAR (Light Detection And Ranging) or the like.

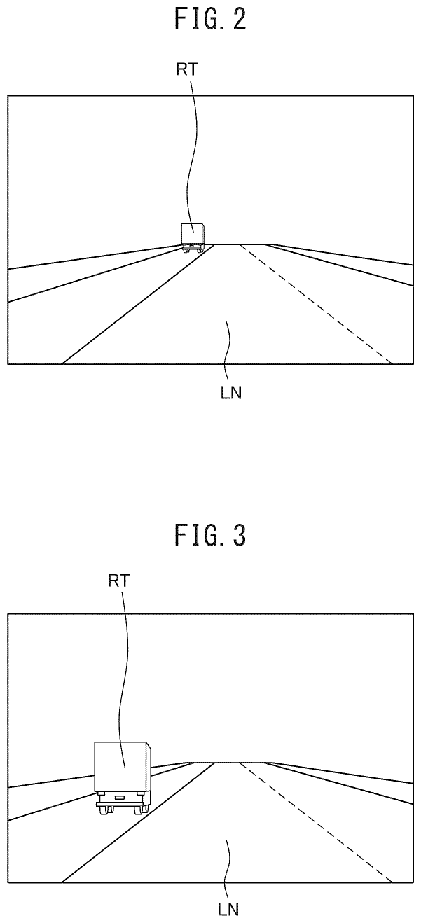

FIG. 2 is a view showing an example of the surrounding situation in front of the host vehicle 1 in the travel direction measured by the surrounding situation sensor 11 at a first time. In detail, FIG. 2 shows the example of an image of front of the host vehicle 1 in the travel direction shot by the camera as the surrounding situation sensor 11 at the first time.

In the example shown in FIG. 2, the surrounding situation sensor 11 is configured by the camera that shoots the front of the host vehicle 1 in the travel direction. The measurement result of the surrounding situation sensor 11 at the first time (image of front of the host vehicle 1 in the travel direction shot by the camera as the surrounding situation sensor 11 at the first time) is used for driving assistance or the like of the host vehicle 1.

The measurement result of the surrounding situation sensor 11 at the first time includes lane LN in which the host vehicle 1 is traveling, truck which is stopping on a road shoulder beside the lane LN and the like. The truck stopping on the road shoulder may move in the lane LN in which the host vehicle 1 is traveling. Therefore, in order to improve safety of the travel of the host vehicle 1, the truck stopping on the road shoulder should be recognized as a recognition target RT.

On the other hand, at the first time, the distance between the host vehicle 1 and the truck stopping on the road shoulder as the recognition target RT is large. Therefore, a recognition process unit 3B to be described later of the data collection device 16 cannot recognize the recognition target RT (truck stopping on the road shoulder) based on the measurement result of the surrounding situation sensor 11 at the first time (image of front of the host vehicle 1 in the travel direction shot by the camera as the surrounding situation sensor 11 at the first time).

FIG. 3 is a view showing an example of the surrounding situation in front of the host vehicle 1 in the travel direction measured by the surrounding situation sensor 11 at a second time which is a time later than the first time. In detail, FIG. 3 shows the example of the image of front of the host vehicle 1 in the travel direction shot by the camera as the surrounding situation sensor 11 at the second time.

As shown in FIG. 3, at the second time, the distance between the host vehicle 1 and the truck stopping on the road shoulder as the recognition target RT is smaller than the first time. Therefore, the recognition process unit 3B of the data collection device 16 can recognize the recognition target RT (truck stopping on the road shoulder) based on the measurement result of the surrounding situation sensor 11 at the second time (image of front of the host vehicle 1 in the travel direction shot by the camera as the surrounding situation sensor 11 at the second time).

In the example shown in FIG. 1, the vehicle condition sensor 12 measures condition of the host vehicle 1 and transmits the measurement result to the vehicle control device 15 and the data collection device 16. The vehicle condition sensor 12 includes, for example, vehicle speed sensor, yaw rate sensor, and the like.

The HMI 13 has the function of receiving various operations of a driver of the host vehicle 1 and the like and transmits signals indicating the operations of the driver of the host vehicle 1 to the vehicle control device 15.

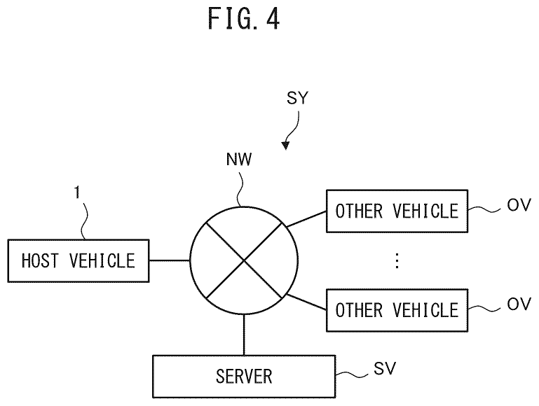

The communication device 14 communicates with the outside of the host vehicle 1 (e.g., server SV (see FIG. 4) and the like).

FIG. 4 is a view showing an example of a relationship between the host vehicle 1 and the server SV and the like.

In the example shown in FIG. 4, the host vehicle 1 and the server SV are configured to be communicable through a network NW. Further, each of the plurality of other vehicle OV and the servers SV are configured to be communicable through the networked NW.

Further, in the example shown in FIG. 4, the server SV, the host vehicle 1 and the plurality of other vehicle OV constitute a data collection system SY, and information such as sensor data obtained in the host vehicle 1 and the plurality of other vehicle OV is collected by the server SV.

In the example shown in FIG. 1, the vehicle control device 15 controls the steering actuator 15A, the braking actuator 15B, and the drive actuator 15C based on the information (data, signals) transmitted from, for example, the surrounding situation sensor 11, the vehicle condition sensor 12, and the HMI 13.

The data collection device 16 collects data such as, for example, the measurement result of the surrounding situation sensor 11, the measurement result of the vehicle condition sensor 12 and the like. The data collection device 16 causes the communication device 14 to perform communication for uploading the data collected from the surrounding situation sensor 11 and the vehicle condition sensor 12 to the server SV. The data collection device 16 is configured by a microcomputer including communication interface (I/F) 161, memory 162, and processor 163.

The communication interface 161 includes an interface circuit for connecting the data collection device 16 to the surrounding situation sensor 11, the vehicle condition sensor 12, the HMI 13, the communication device 14, and the vehicle control device 15. The memory 162 stores a program used in a process performed by the processor 163 and various data. In detail, the memory 162 stores sensor information indicating a mounting position of the surrounding situation sensor 11 with respect to the host vehicle 1, sensor information indicating posture of the surrounding situation sensor 11 with respect to the host vehicle 1, and the like. The processor 163 has the function as an acquisition unit 3A, the function as the recognition process unit 3B, the function as a determination unit 3C, and the function as an upload process unit 3D.

In the example shown in FIG. 1, the acquisition unit 3A acquires the measurement result (measurement result of the surrounding situation in front of the host vehicle 1 in the travel direction) of the surrounding situation sensor 11 from the surrounding situation sensor 11.

In the example shown in FIG. 2, the acquisition unit 3A acquires the measurement result of the surrounding situation sensor 11 at the first time (image of front of the host vehicle 1 in the travel direction shot by the camera as the surrounding situation sensor 11 at the first time).

In the example shown in FIG. 3, the acquisition unit 3A acquires the measurement result of the surrounding situation sensor 11 at the second time after the first time (image of front of the host vehicle 1 in the travel direction shot by the camera as the surrounding situation sensor 11 at the second time).

In the example shown in FIG. 1, the acquisition unit 3A acquires the sensor information indicating the mounting position of the surrounding situation sensor 11 with respect to the host vehicle 1, the sensor information indicating the posture of the surrounding situation sensor 11 and the like from the memory 162. Furthermore, the acquisition unit 3A acquires the measurement result (vehicle information indicating the condition of the host vehicle 1 such as the vehicle speed, the yaw rate and the like) of the vehicle condition sensor 12 from the vehicle condition sensor 12.

In the example shown in FIG. 2, the acquisition unit 3A acquires the measurement result of the vehicle condition sensor 12 at the first time from the vehicle condition sensor 12.

In the example shown in FIG. 3, the acquisition unit 3A acquires the measurement result of the vehicle condition sensor 12 at the second time from the vehicle condition sensor 12.

In the example shown in FIG. 1, the recognition process unit 3B recognizes the recognition target RT (see FIG. 2 and FIG. 3) included in the measurement result of the surrounding situation sensor 11 acquired by the acquisition unit 3A based on the measurement result of the surrounding situation sensor 11. Specifically, the recognition process unit 3B recognizes the recognition target RT included in the measurement result of the surrounding situation sensor 11 (identifies attribute or the like of the recognition target RT) based on the measurement result of the surrounding situation sensor 11 by using a model obtained by performing learning using teacher data which is a data set of, for example, measurement result of the surrounding situation sensor mounted on a learning vehicle and a label indicating the attribute or the like of the recognition target measured by the surrounding situation sensor (label indicating what the recognition target measured by the surrounding situation sensor is).

In the example shown in FIG. 2, the recognition process unit 3B tries to recognize the recognition target RT (truck stopping on the road shoulder) included in the measurement result of the surrounding situation sensor 11 based on the measurement result of the surrounding situation sensor 11 at the first time acquired by the acquisition unit 3A (image of front of the host vehicle 1 in the travel direction shot by the camera as the surrounding situation sensor 11 at the first time).

On the other hand, as described above, at the first time, the distance between the host vehicle 1 and the truck stopping on the road shoulder as the recognition target RT is large. Therefore, the recognition process unit 3B cannot recognize the recognition target RT based on the measurement result of the surrounding situation sensor 11 at the first time.

Therefore, in the example shown in FIG. 1, for example, measures to be described later are implemented so that the recognition process unit 3B can recognize the recognition target RT based (only) on the measurement result of the surrounding situation sensor 11 at the first time.

In the example shown in FIG. 3, the recognition process unit 3B can recognize the recognition target RT (truck stopping on the road shoulder) included in the measurement result of the surrounding situation sensor 11 based on the measurement result of the surrounding situation sensor 11 at the second time acquired by the acquisition unit 3A (image of front of the host vehicle 1 in the travel direction shot by the camera as the surrounding situation sensor 11 at the second time).

As a measure for enabling the recognition process unit 3B to recognize the recognition target RT based (only) on the measurement result of the surrounding situation sensor 11 at the first time, in the example shown in FIG. 1, the determination unit 3C determines whether the result of recognition of the recognition target RT included in the measurement result of the surrounding situation sensor 11 at the first time performed by the recognition process unit 3B by using the measurement result of the surrounding situation sensor 11 at the first time (image of front of the host vehicle 1 in the travel direction shot by the camera as the surrounding situation sensor 11 at the first time) and the result of the recognition of the recognition target RT included in the measurement result of the surrounding situation sensor 11 at the second time performed by the recognition process unit 3B by using the measurement result of the surrounding situation sensor 11 at the second time (image of front of the host vehicle 1 in the travel direction shot by the camera as the surrounding situation sensor 11 at the second time) coincide.

Furthermore, in the example shown in FIG. 1, when the determination unit 3C determines that the recognition result of the recognition target RT included in the measurement result of the surrounding situation sensor 11 at the first time and the recognition result of the recognition target RT included in the measurement result of the surrounding situation sensor 11 at the second time do not coincide, the upload process unit 3D performs a process of uploading the measurement result of the surrounding situation sensor 11 at the first time used for the recognition of the recognition target RT including in the measurement result of the surrounding situation sensor 11 at the first time and the measurement result of the surrounding situation sensor 11 at the second time used for the recognition of the recognition target RT including in the measurement result of the surrounding situation sensor 11 at the second time to the server SV.

Specifically, in the example shown in FIG. 2 and FIG. 3 (example in which the recognition process unit 3B cannot recognize the recognition target RT based on the measurement result of the surrounding situation sensor 11 at the first time and can recognize the recognition target RT based on the measurement result of the surrounding situation sensor 11 at the second time), the upload process unit 3D performs the process of uploading the measurement result of the surrounding situation sensor 11 at the first time and the measurement result of the surrounding situation sensor 11 at the second time to the server SV.

The server SV not only collects the measurement result of the surrounding situation sensor 11 at the first time and the second time from the host vehicle 1, but also collects the attribute or the like of the recognition target RT recognized by the recognition process unit 3B (used as label in additional learning of the model to be described later) based on the measurement result of the surrounding situation sensor 11 at the second time from the host vehicle 1. Further, the server SV performs the additional learning of the model used by the recognition process unit 3B to recognize the recognition target RT included in the measurement result of the surrounding situation sensor 11 by using the measurement result of the surrounding situation sensor 11 at the first time and the second time and the attribute or the like of the recognition target RT collected from the host vehicle 1.

The recognition process unit 3B can recognize the recognition target RT based only on the measurement result of the surrounding situation sensor 11 at the first time by using the model of which the additional learning is performed by the server SV (that is, without being based on the measurement result of the surrounding situation sensor 11 at the second time), although the recognition process unit 3B cannot recognize the recognition target RT based only on the measurement result of the surrounding situation sensor 11 at the first time before the additional learning of the model is performed.

That is, when the surrounding situation in front of the travel direction is measured by the surrounding situation sensor 11 mounted on the host vehicle 1 moving forward in the travel direction as in the example shown in FIG. 2 and FIG. 3, the later time, the closer the surrounding situation sensor 11 is to the recognition target RT located in front of the host vehicle 1 in the travel direction. Therefore, the later time, more correct the result of the recognition of the recognition target RT performed by using the measurement result of the surrounding situation sensor 11. On the other hand, the result of the recognition of the recognition target RT performed by using the measurement result of the surrounding situation sensor 11 obtained when the surrounding situation sensor 11 is away from the recognition target RT is different from the correct recognition result (is the erroneous recognition result). The measurement result of the surrounding situation sensor 11 obtained at that time is considered to be the measurement result with issues. The measurement result with issues can be extracted at the timing when the recognition result switches from the wrong recognition result to the correct recognition result with the movement of the host vehicle 1.

More specifically, in the example shown in FIG. 2 and FIG. 3 (example in which the recognition process unit 3B cannot recognize the recognition target RT based on the measurement result of the surrounding situation sensor 11 at the first time and can recognize the recognition target RT based on the measurement result of the surrounding situation sensor 11 at the second time), the upload process unit 3D does not upload only the measurement result of the surrounding situation sensor 11 at the first time to the server SV wherein the recognition target 3B cannot recognize the recognition target RT based on the measurement result of the surrounding situation sensor 11 at the first time, but performs the process of uploading time series measurement result of the surrounding situation sensor 11 including the measurement result of the surrounding situation sensor 11 at the first time wherein the recognition target 3B cannot recognize the recognition target RT based on the measurement result of the surrounding situation sensor 11 at the first time and the measurement result of the surrounding situation sensor 11 at the second time wherein the recognition target 3B can recognize the recognition target RT based on the measurement result of the surrounding situation sensor 11 at the second time, to the server SV. As a result, it is possible to ensure that the recognition process unit 3B can recognize the recognition target RT based on only the measurement result of the surrounding situation sensor 11 at the first time more reliably than a case in which only the measurement result of the surrounding situation sensor 11 is uploaded to the server SV wherein the recognition target 3B cannot recognize the recognition target RT based on the measurement result of the surrounding situation sensor 11 at the first time.

In modification of the example shown in FIG. 2 and FIG. 3 (example in which the recognition process unit 3B cannot recognize the recognition target RT based on the measurement result of the surrounding situation sensor 11 at the first time and can recognize the recognition target RT based on the measurement result of the surrounding situation sensor 11 at the second time), the upload process unit 3D not only uploads the measurement result of the surrounding situation sensor 11 to the server SV, but also performs the process of uploading the sensor information indicating the mounting position of the surrounding situation sensor 11 with respect to the host vehicle 1, the sensor information indicating the posture of the surrounding situation sensor 11 with respect to the host vehicle 1, and the vehicle information indicating the condition of the host vehicle 1 such as the vehicle speed, the yaw rate and the like acquired by the acquisition unit 3A to the server SV.

The server SV not only collects the measurement result of the surrounding situation sensor 11 at the first time from the host vehicle 1, but also collects the attribute or the like of the recognition target RT recognized by the recognition process unit 3B (used as the label in the additional learning of the model) based on the measurement result of the surrounding situation sensor 11 at the second time from the host vehicle 1. Further, the server SV collects the sensor information indicating the mounting position of the surrounding situation sensor 11 with respect to the host vehicle 1, the sensor information indicating the posture of the surrounding situation sensor 11 with respect to the host vehicle 1, and the vehicle information indicating the condition of the host vehicle 1 such as the vehicle speed, the yaw rate, and the like from the host vehicle 1. Further, the server SV performs the additional learning of the model used by the recognition process unit 3B by using the measurement result of the surrounding situation sensor 11 collected from the host vehicle 1, the attribute or the like of the recognition target RT, the sensor information indicating the mounting position of the surrounding situation sensor 11 with respect to the host vehicle 1, the sensor information indicating the posture of the surrounding situation sensor 11 with respect to the host vehicle 1, and the vehicle information indicating the condition of the host vehicle 1 such as the vehicle speed, the yaw rate and the like so that the recognition process unit 3B can recognize the recognition target RT based on the measurement result of the surrounding situation sensor 11 at the first time.

The recognition process unit 3B can recognize the recognition target RT based on the measurement result of the surrounding situation sensor 11 at the first time wherein the recognition process unit 3B cannot recognize the recognition target RT before the additional learning of the model is performed by the server SV, the sensor information indicating the mounting position of the surrounding situation sensor 11 with respect to the host vehicle 1, the sensor information indicating the posture of the surrounding situation sensor 11 with respect to the host vehicle 1, and the vehicle information indicating the condition of the host vehicle 1 such as the vehicle speed, the yaw rate and the like (that is, without being based on the measurement result of the surrounding situation sensor 11 at the second time) by using the model of which the additional learning is performed by the server SV.

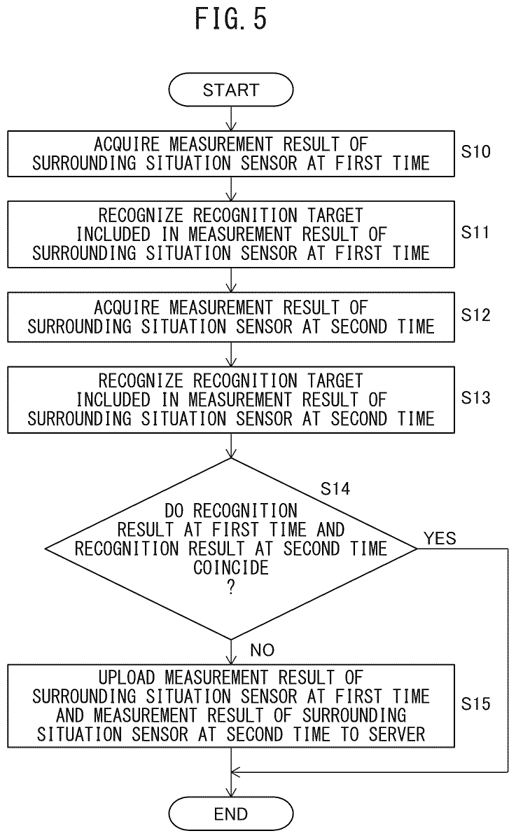

FIG. 5 is a flowchart for explaining an example of the process performed by the processor 163 of the data collection device 16 of the first embodiment.

In the example shown in FIG. 5, at step S10, the acquisition unit 3A acquires the measurement result of the surrounding situation sensor 11 at the first time from the surrounding situation sensor 11.

At step S11, the recognition process unit 3B recognizes (more specifically, tries to recognize) the recognition target RT included in the measurement result of the surrounding situation sensor 11 at the first time based on the measurement result of the surrounding situation sensor 11 at the first time acquired at step S10.

At step S12, the acquisition unit 3A acquires the measurement result of the surrounding situation sensor 11 at the second time from the surrounding situation sensor 11.

At step S13, the recognition process unit 3B recognizes (more specifically, tries to recognize) the recognition target RT included in the measurement result of the surrounding situation sensor 11 at the second time based on the measurement result of the surrounding situation sensor 11 at the second time acquired at step S12.

At step S14, the determination unit 3C determines whether the result of the recognition of the recognition target RT included in the measurement result of the surrounding situation sensor 11 at the first time executed at step S11 and the result of the recognition of the recognition target RT included in the measurement result of the surrounding situation sensor 11 at the second time executed at step S13 coincide. When YES, the process shown in FIG. 5 ends; when NO, it proceeds to step S15.

At step S15, the upload process unit 3D performs the process of uploading the measurement result of the surrounding situation sensor 11 at the first time acquired at step S10 and the measurement result of the surrounding situation sensor 11 at the second time acquired at step S12 to the server SV.

### Second Embodiment

The host vehicle 1 to which the data collection device 16 of a second embodiment is applied is configured similarly to the host vehicle 1 to which the data collection device 16 of the first embodiment described above is applied, except for the points to be described later.

In the example (example of the host vehicle 1 to which the data collection device 16 of the first embodiment is applied) shown in FIG. 1 as described above, AI (artificial intelligence) is not mounted in the surrounding situation sensor 11, and the processor 163 has the function as the recognition process unit 3B which recognizes the recognition target RT included in the measurement result of the surrounding situation sensor 11 based on the measurement result of the surrounding situation sensor 11.

On the other hand, in an example of the host vehicle 1 to which the data collection device 16 of the second embodiment is applied, the surrounding situation sensor 11 has the function of recognizing the recognition target RT included in the measurement result of the surrounding situation sensor 11 based on the measurement result of the surrounding situation sensor 11.

In the example of the host vehicle 1 to which the data collection device 16 of the second embodiment is applied, the acquisition unit 3A acquires the measurement result of the surrounding situation sensor 11 and the recognition result of the recognition target RT included in the measurement result of the surrounding situation sensor 11 from the surrounding situation sensor 11.

In the example of the host vehicle 1 to which the data collection device 16 of the second embodiment is applied, when the surrounding situation sensor 11 cannot recognize the recognition target RT based on the measurement result of the surrounding situation sensor 11 at the first time and when the surrounding situation sensor 11 can recognize the recognition target RT based on the measurement result of the surrounding situation sensor 11 at the second time, the upload process unit 3D performs the process of uploading the measurement result of the surrounding situation sensor 11 at the first time and the measurement result of the surrounding situation sensor 11 at the second time to the server SV.

The server SV not only collects the measurement result of the surrounding situation sensor 11 at the first time and the measurement result of the surrounding situation sensor 11 at the second time from the host vehicle 1, but also collects the attribute or the like of the recognition target RT recognized by the surrounding situation sensor 11 (used as the label in the additional learning of the model) based on the measurement result of the surrounding situation sensor 11 at the second time from the host vehicle 1. Further, the server SV performs the additional learning of the model used by the surrounding situation sensor 11 to recognize the recognition target RT included in the measurement result of the surrounding situation sensor 11 by using the measurement result of the surrounding situation sensor 11 at the first time collected from the host vehicle 1 and the attribute or the like of the recognition target RT.

The surrounding situation sensor 11 can recognize the recognition target RT based only on the measurement result of the surrounding situation sensor 11 at the first time wherein the surrounding situation sensor 11 cannot recognize the recognition target RT before the additional learning of the model is performed by the server SV (that is, without being based on the measurement result of the surrounding situation sensor 11 at the second time) by using the model of which the additional learning is performed by the server SV.

As described above, although the embodiments of the data collection device, the data collection method, and the non-transitory recording medium of the present disclosure have been described with reference to the drawings, the data collection device, the data collection method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the data collection device 16 has been described as software process performed by executing the program, but the process performed in the data collection device 16 may be process performed by hardware. Alternatively, the process performed by the data collection device 16 may be a combination of both software and hardware. Further, the program (program for realizing the function of the processor 163 of the data collection device 16) stored in the memory 162 of the data collection device 16 may be recorded in a computer-readable storage medium (non-transitory recording medium) such as, semiconductor memory, magnetic recording medium, optical recording medium, or the like for providing, distribution or the like.

1. A data collection device comprising a processor configured to:
acquire at least measurement result of a surrounding situation in front of a host vehicle in a travel direction from a surrounding situation sensor which measures the surrounding situation;
determine whether recognition result of a recognition target included in the surrounding situation at a first time and the recognition result of the recognition target at a second time which is a time later than the first time coincide, recognition of the recognition target being performed by using the measurement result of the surrounding situation; and
perform a process of uploading the measurement result used for the recognition of the recognition target at the first time and the measurement result used for the recognition of the recognition target at the second time to a server when it is determined that the recognition result of the recognition target at the first time and the recognition result of the recognition target at the second time do not coincide.

2. The data collection device according to claim 1, wherein the processor is configured to perform the process of uploading time series measurement result including the measurement result used for the recognition of the recognition target at the first time and the measurement result used for the recognition of the recognition target at the second time to the server.

3. The data collection device according to claim 1, wherein the processor is configured to
acquire sensor information indicating mounting position and posture of the surrounding situation sensor with respect to the host vehicle and vehicle information indicating speed and yaw rate of the host vehicle, and
perform the process of uploading the sensor information and the vehicle information to the server.

4. A data collection method comprising:
acquiring at least measurement result of a surrounding situation in front of a host vehicle in a travel direction from a surrounding situation sensor which measures the surrounding situation;
determining whether recognition result of a recognition target included in the surrounding situation at a first time and the recognition result of the recognition target at a second time which is a time later than the first time coincide, recognition of the recognition target being performed by using the measurement result of the surrounding situation; and
performing a process of uploading the measurement result used for the recognition of the recognition target at the first time and the measurement result used for the recognition of the recognition target at the second time to a server when it is determined that the recognition result of the recognition target at the first time and the recognition result of the recognition target at the second time do not coincide.

5. A non-transitory recording medium having recorded thereon a computer program for causing a processor to perform a process comprising:
acquiring at least measurement result of a surrounding situation in front of a host vehicle in a travel direction from a surrounding situation sensor which measures the surrounding situation;
determining whether recognition result of a recognition target included in the surrounding situation at a first time and the recognition result of the recognition target at a second time which is a time later than the first time coincide, recognition of the recognition target being performed by using the measurement result of the surrounding situation; and
performing a process of uploading the measurement result used for the recognition of the recognition target at the first time and the measurement result used for the recognition of the recognition target at the second time to a server when it is determined that the recognition result of the recognition target at the first time and the recognition result of the recognition target at the second time do not coincide.
